(19) United States
(12) Patent Application Publication
(10) Pub. No.: US 2003/0213502 A1
(43) Pub. Date: Nov. 20, 2003

(54) Vehicle cleaning system

(76) Inventor: Tord Georg Eriksson, Jarfalla (SE)

Correspondence Address: VALARIE ERIKSSON, C/O SCHAUT, 8267 SHEPARD RD., MACEDONIA, OH, 44056, US

(21) Appl. No.: 10/146,299

(22) Filed: May 15, 2002

(51) Int. Cl. B60S 3/04

(52) U.S. Cl. 134/10; 134/26; 134/111; 134/123

(57) ABSTRACT

Process and plant for washing without waste water discharges. The washing is done with recycling wash water, which is continuously purified and regenerated between each use. The rinsing is done in at least two stages. The wash water and the rinse water are recycled in two separate circuits balanced against each other in such a way that the water additions to the system may be limited to correspond to the losses through withdraw. In this way the plant can operate without generating surplus of wash water that must be discharged to the sewage system.

Discharge from the cleaning of vehicles and similar objects is an important environmental problem. A method for a partial solution of the problem is described in PCT/SE95/00477, where one uses a recycling wash solution, which is purified continuously by sedimentation and filtering after addition of a cleavage agent, consisting of soluble, not complexing salts with two or more anionic valences. The result can be reduction of the water consumption with more than 80% and reduction of discharges that are environmentally disturbing with more than 90%. The method has very high cost efficiency. The system may be designed to ensure that the corrosion resistance of the vehicles is bettered.

A similar way of approaching the problem is described in the American patent publication U.S. Pat. No. 4,135,533. According to this publication three, separate circuits are used for pre-wetting, washing and rinsing. The only purification included in the system is coagulation, without chemical additions, and separation of solid impurities by hydro-cyclones and filtration. The system is designed for the washing of railroad cars and locomotives. The demands on such washing differ very much from the demands for washing of road vehicles, especially passenger cars. This concerns especially the moments rinsing and drying. Here the demand is, for motor cars and especially passenger cars, that the surface after drying must have high lustre and be completely free from haziness or drying spots.

Another variant of the same theme is described in GB 1 407 894, which refers to washing of motor cars. Here too, separate circuits are used for washing and rinsing. Both circuits include purification by oil separation with the aid of so-called skimmers. The washing circuit includes separation of solid impurities by a hydro-cyclone. The washing circuit includes filtration to eliminate impurities. Reverse osmosis (RO.) is mentioned as a possibility for salt elimination wintertime, when road salt is part of the dirt. No description of how this could be used in a constructive way to eliminate salt spots at the drying can be found in the publication.

SE 501 044 describes a system, where one, without other purification measures than the sedimentation, which happens in the, for practical reasons, comparatively small intermediate tanks, reuses dirty water for the washing respectively rinsing. Thus, this invention refers to a counter-current system with several circuits without integrated purification.

At washing water losses occur caused by the fact that every washed vehicle leaves the wash with some water. Further the fine dispersion of water created by brushes and high-pressure guns gives good opportunities for evaporation and formation of air borne water aerosols. Part of the water vapour and the water aerosols leaves the wash room with the air in the ventilation system. Other parts are precipitated on machines, walls, ceiling and floor and returned to the circuit. A comprehensive common designation for the water losses is “withdraw”.

The water losses fluctuate from car type to car type and depending on used wash techniques, time of the year and weather. A common estimate is in average 15 litres per vehicle. In closed systems for vehicle cleaning, the withdraw is used to keep the content of water-soluble impurities down. The water-soluble impurities are partly organic, partly inorganic. The latter ones are mainly salts. The impurities come only partially from the dirt. Other sources are tap water, which contains important quantity salt of different kinds. The salt concentration increases, when water is lost as water vapour. However, the main source is the counter ions accompanying the different agents used for defatting, cleaning and rinsing.

Experiences confirm that the withdraw is not sufficient for keeping the salt concentrations at an acceptable level in a system with total recycling of wash and rinse water. Now and then the systems must be emptied completely and the wash water replaced by fresh water to restore expected functions.

Even if one accepts periodic emptying, rinsing and drying are often problematic in system with total recycling. Even common tap water contains enough salt to cause drying spots if conditions are unfavourable. This becomes especially embarrassing, when the rinsing is done with recycled water contaminated with salt from earlier stages of the process.

Another problem is that the withdraw varies considerably from vehicle to vehicle and is influenced by current weather conditions. A functioning recycling system without bleeding-off to the sewage disposal system must allow for all these factors.

According to the present invention those problems are solved by adding a separate balancing circuit to the two circuits for washing and rinsing mentioned in U.S. Pat. No. 4,135,533 and GB 1 407 894. This balancing circuit returns contaminated water from an earlier stage in the process, with respect to the washing, to the rinse section, purifies the water as described below, and then reuses it for the final rinsing together with the freshwater addition allowed by the withdraw.

The wash process of the invention can be done on an immobile vehicle in one treatment station. This may be recommended for comparatively small new units and such rebuilding, where difficulties arise installing a separate hall for rinsing and drying.

For new construction of comparatively large plants a design is recommended that allows the vehicle to be moved, after the wash phase and before the rinse phase to a separate room, where rinsing and drying take place. The rooms should be separated so that earlier mentioned, air carried water aerosol cannot spread from the wash zone to the rinse zone.

Beside the variations mentioned with respect to the size of the withdraw the balancing of the two circuits against each other is complicated by the fact that it sometimes may happen that the withdraw becomes very small or even negative, i.e. that the motor car is accompanied with more water driving in into the wash plant when leaving it. Normally car wash is a “fine weather activity”. However, after long periods of rain and snow the need for cleaning may be so large that the wash cannot be postponed. For many vehicles regular wash is requested irrespective of weather.

An important part in a plant without bleeding-off is a balancing system. According to the present invention a balancing circuit is used. Several alternatives for the design of such a circuit depending on which demands besides the balancing one wants to make. A few preferred varieties are described below.

Water losses by withdraw and in sludge must be compensated, but the added water does not need to be of fresh water quality. Collected rainwater is quite useful and also other water, which may be available. Even brackish water and salt water can be used if the system is suitably designed.

The present invention refers to a wash plant without bleeding-off and with a recycling system for wash water, a recycling system for rinse water and a balancing system in the shape of a circuit, which reclaims contaminated water from an earlier stage in the cleaning process, from the washing aspect, purifies the water and uses it for final rinsing.

Even if methods and equipment according to the invention primarily are intended for eliminating all discharges to water from plants for vehicle washes, of course, they may be used in other wash situations concerning solid objects, where it is desirable to avoid discharges or where one needs salt-free water, for instance, when fresh water of suitable quality for rinsing is lacking.

In one preferred embodiment of the invention a slightly modified conventional oil separator is used as combined water source for the wash circuit and sewage sump for the whole system. The sludge collects little by little in the lower part of the oil separator. When the sludge layer approaches the upper border of the partition dividing the separator proper from the recycling chamber, the separator is emptied by sludge sucking. At completing of existing plants that have oil separators to systems without discharges, this is usually the best design.

However, it should be noted that a system without discharge could be designed with more freedom than the case is if one has to calculate with discharges to the sewage system. The discharge regulations given by the authorities do not apply here. This implies good opportunities for simplified systems. For instance one may over-dimension the wash-gutter to eliminate the need for a separate oil/sludge separator. This gives ample opportunities for using the space below the wash room.

For new plants systems that, more or less continuously, separate and de-water sludge may be preferable. Such a system eliminates the start-up problem and the shock load with respect to water and chemicals associated with the start of the system after sludge sucking. Techniques for continuous sludge separation and dewatering are known. An example is the hydro-cyclones mentioned in the American and the British patent described.

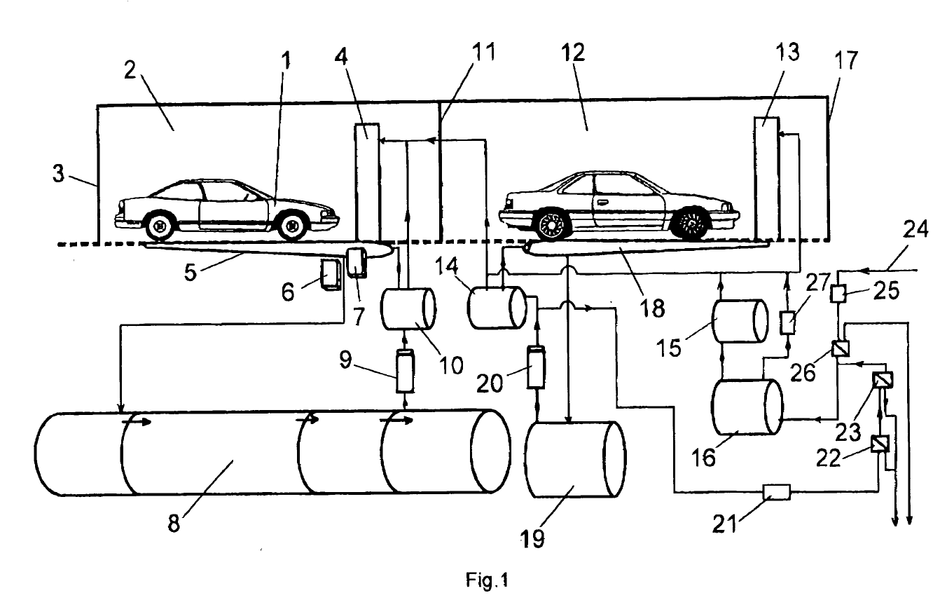

Accompanying FIGS. 1 to 3 show sketches referring to three, different, preferred embodiments of the invention. The units in the sketches are defined in the following function description.

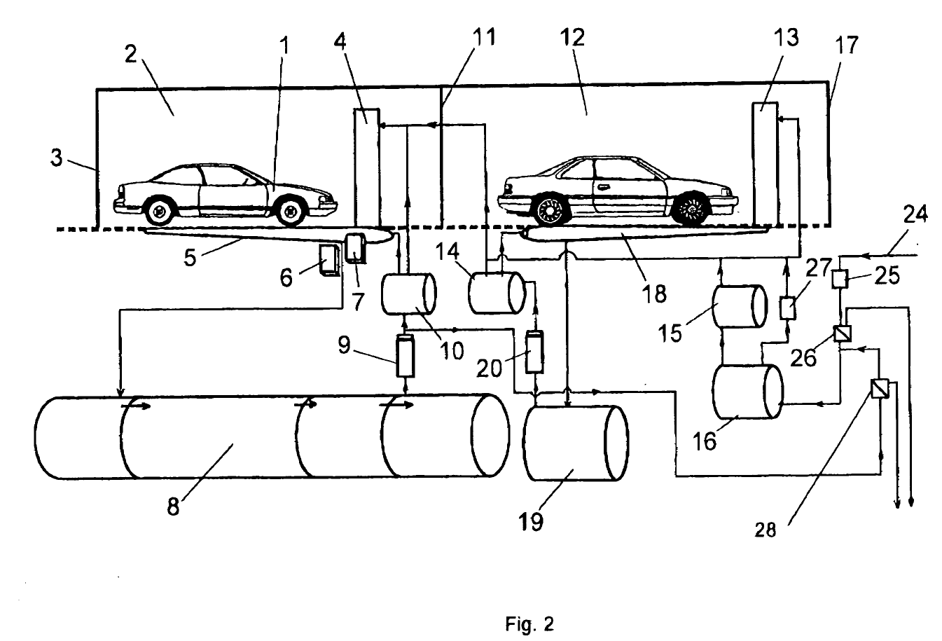

According to FIGS. 1 and 2 the process follows the following scheme. A vehicle (1), intended to be washed, is driven in into the wash room (2) through the entrance gate (3) and stops, when the signal at the rack (4) shows red. When the vehicle has stopped, the rack moves over the vehicle. The rack serves as support for a system for applying a defatting agent, a high-pressure system with contour-following arms and a brush system. When a complete wash program has been ordered, the rack moves itself three to five times over the vehicle. At the first passage a special defatting agent is applied on the surfaces that are normally subjected to fouling by asphalt-splashing, only, i.e. the lower part of the car body up to a height between 50 and 70 centimetres from the ground level. At the next passage a defatting agent may be applied to the car body. This operation is needed wintertime only. At the next passage high pressure is used for removing coarse dirt that might scratch the finish using brushes. At the third or fourth passage depending upon time of the year very soft brushes are used.

In parallel with the wash passages high-pressure guns placed under the vehicle wash the chassis. The fourth (fifth) passage is a pre-rinse. This may be deleted if no water addition to the wash system is needed. This may be the case if the vehicles are rain-wet or are carrying substantial amounts of snow. However, usually water additions are required, especially if, as described below, the balancing circuit starts from the wash circuit and includes distillation.

The contaminated wash water is collected in the wash-gutter (5). Simultaneously may, if judged appropriate, precipitation agents be added from the devices (6) and (7). Wash water and precipitation agents flow forward to the sludge separator (8), which may be situated underground. At the far end of the sludge separator, counted from the inlet, water purified by sedimentation in the sludge separator is pumped to a sand-filter (9) and is after that directed to the buffer-tank (10). The buffer-tank serves as a sump for the pumps providing the wash rack (4) with wash water. It is preferred to direct a small flow from the buffer-tank back to the wash-gutter (5) to cause a permanent circulation of water through the system. In this way formation of hydrogen sulphide and other evil smelling substances is prevented. It is also preferred that the water in the buffer-tank and in the last section of the sludge separator is aerated, i.e. is agitated by letting air bubble through. If needed cleaning agents are added to compensate for the loss at the purification in or after the buffer-tank (10)

When the wash phase is ended, i.e. when the rack (4) has completed its three to five rounds over the vehicle it stops and the gate (11) is opened. The vehicle is started and driven in into the rinsing/drying room (12) and stopped, when the signal at the rack (13) shows red. The rack (13) supports systems for application of sheeting agent and rinse water and dry blowing of the vehicle. At the first passage of the rack a first rinsing with already used rinse water from the buffer-tank (14) is made. At the second passage one rinses with water from the pump sump (15). This water has been pretreated by RO-filtration and/or distillation and contains agents for obtaining improved sheeting and lustre. At the third passage one rinses with RO-treated and/or distilled water, with or without additives, from the buffer-tank (16). The third passage may be omitted if the result after two rinses is judged to be satisfactory. Finally water is blown off from the vehicle, which after that deserts the wash via the exit gate (17).

Rinse water is collected in the gutter (18) and flows from there to the collecting tank (19). From the collecting tank water is pumped through the sand-filter (20) to the buffer-tank (14) and from there to a pre-rinse via the wash rack (4) and a first rinse in the rinsing/drying room via the rinsing rack (13). It is preferred to let a small flow go back to the gutter (18) to avoid stagnant water in the gutter causing hydrogen sulphide formation by anaerobe decomposition.

FIG. 1 shows that a partial current belonging to the balancing circuit before the buffer-tank is diverted to a textile filter (21) and from there to an ultra filter (22). Accept from the ultra filter (22) is led to a RO-filter (23). Accept from this filter is directed to the buffer-tank (16). Rejects from the ultra filter (22) and the RO-filter (23) contain some wash and rinse chemicals. This reject is returned to the recycling system either to the sludge separator (8) or to preparation of solutions of precipitating chemicals. Such a system provides for requirements for ion-depleted water for rinsing but is less effective with respect to retarding of the salt accumulation than the following one. Thus it can be recommended only where added freshwater has extremely low ion content.

FIG. 2, which otherwise is identical to FIG. 1, shows that instead the partial current belonging to the balancing circuit is taken from the buffer-tank for wash-water 10 and is led to a distiller 28. With great advantage one may use a vacuum distiller working at comparatively low temperature and including energy recovery. The reject from the distiller should be taken care of separately to obtain earlier mentioned advantages of elimination of water-soluble impurities. This system provides for all demands that may be put on a well-designed balancing circuit. Therefor it is strongly preferred.

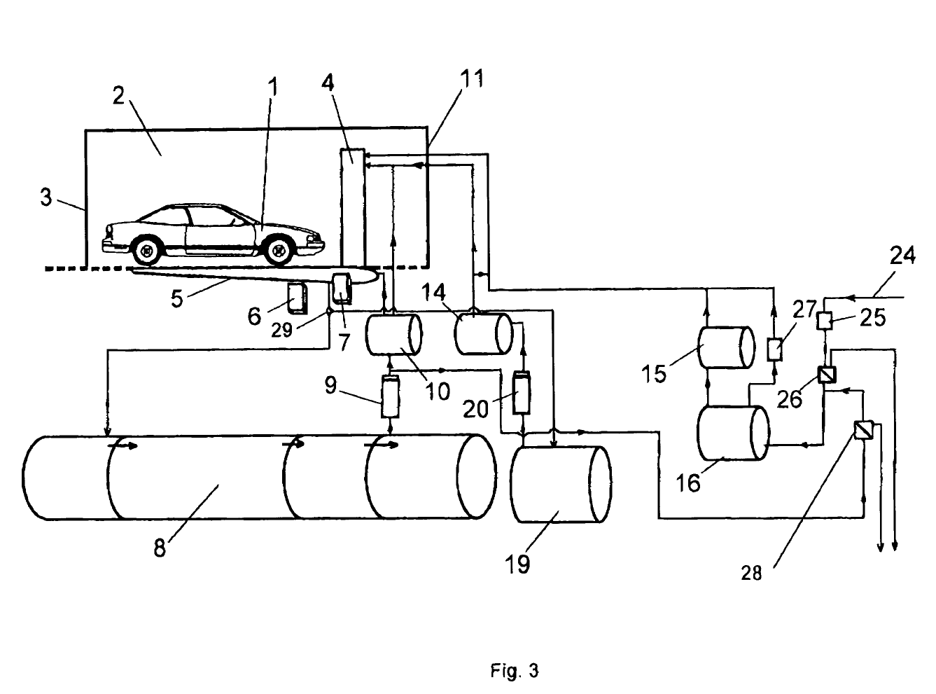

FIG. 3 shows a purification system identical to the one of FIG. 2. The separate rinsing/drying unit 12 with the rinsing/drying rack 13 has been deleted and replaced by completing the wash rack 4 with the functions that, according to FIGS. 1 and 2, belonged to the drying rack 13. This new rack is designated 4a. Further an arrangement 29 has been added for diverting water from the wash-gutter 5 to either the sludge/oil-separator 8 or a corresponding separator for rinse water 19. No high sealing demands are put on this arrangement. It may therefor be very simple and may be designed so that its function is not disturbed by the fact that it has to work with dirty water.

The modifications are reflected in the wash routine. It is identical to the routines according to FIGS. 1 and 2 up to the sentence: “When the wash phase is ended, i.e. when the rack (4) has completed its three to five rounds over the vehicle, it stops . . . . ” Instead of moving the vehicle to the rinsing/drying room (12) it is left where it is, while the diverting conduit from the wash-gutter is shifted over to the rinsing position. Here the combined washing/rinsing/drying rack (4b) carries systems for application of sheeting agents and rinse water and dry-blowing the vehicle, beside the wash system. At the rack's first passage, after the shifting-over, a first rinse is made with already used rinse water from the buffer-tank (14). At the second passage rinsing is done with water from the pump sump (15). This water has been pre-treated with RO-filtration and/or distillation and has got additions of lustre and sheeting agents. At the third passage one rinses with RO-treated and/or distilled water, with or without additives, from the buffer-tank (16). The third passage is optional and may be deleted if the result after two rinses is judged satisfactory. After that the routines are identical again.

Normally the vehicles leave the wash wetter than when they were driven in. Inter alia, air in doors and open spaces in the beams of the framework, giving the vehicle stability, has been partly replaced by water. Further water is lost by evaporation and formation of air carried water fog. To compensate for this, water must be added. This may be done from the tap water system or another suitable source. In the examples according to the sketches tap water is added through the pipe (24), softened in a softening filter (25) and after that RO-treated in an RO-filter (26). The accept from the RO-filter is led to the buffer-tank (16). The reject contains just salts that can be found in tap water, already, and may without hesitations be directed to the sewage system. It may also be used for instance for preparing one kind of precipitating chemicals. The production of RO-treated water in the filter (26) is adjusted to the need for water to keep the water level in the system constant. In the alternatives with a distiller no pre-treatment is required, if available water is soft. Beside the mentioned units the rinsing system includes a water heater (27).

In the sketch in FIG. 1 the balancing circuit includes a conduit that branches from the conduit between the sand-filter (20) and the buffer-tank (14), advances to the textile filter (21), to the ultra filter (22) and the RO-filter (23) and after that joins the main circuit for rinsing in the buffer-tank (16). In the example above the balancing circuit includes a carbon filter, an ultra filter and an RO-filter.

In the sketches in the FIGS. 2 and 3, the three filters are replaced by a distillation unit 28, and the balancing circuit starts from the inlet to the buffer-tank 10 instead of from the inlet to the buffer-tank 14. One advantage with using a distiller is that it cannot be poisoned by fouling and inactivation, which may happen for ultra and RO-filters. Therefor, the distiller 28 can work with the very dirty water in the wash circuit instead of the comparatively pure water in the rinse circuit. This gives a much more conclusive result with respect to retardation of salt accumulation. Further distillation can give a reject with high dry matter content, which may even be used as fuel at destruction of other environmentally dangerous wastes. Thus no large problems exists for taking care of this reject separately, i.e. without leading it to the oil separator.

A balancing circuit with this design may act as a “kidney” preventing salt accumulation after long service. As mentioned salt accumulation often requires total emptying of the oil separator before its capacity for sludge collecting is completely exhausted. A disadvantage with a distiller may be a slightly larger space requirement and higher energy costs for the running. Beside the principle of one single type of waste is broken. If the sludge is de-watered in place continuously or intermittently the need becomes larger for distillation for retarding salt accumulation.

If common tap water with normal content of hardness formers and salts is used, a distiller is the better solution from the aspect of total costs, especially if one also wants opportunity to remove the sludge without total emptying of the oil separator. In rare cases, where rainwater or corresponding ion-depleted water may be used, the filter model is a possible alternative.

The balancing circuit may have comparative low capacity. The requirement for reclaimed water, as distilled or ultra/RO-treated water, is at the level of 10 to 30 litres per washed vehicle concerning passenger cars. The higher level refers to the system of FIG. 3. The capacity figures refer to washing of passenger cars. At washes of trucks and tank-cars calculations become different. Probably, in such cases the need for preventing high accumulations of water-soluble impurities in the wash water and the requirement for having pure water for the rinsing of the tanks becomes decisive for the dimensioning.

It should be noted that the described wash routines according to FIGS. 1 to 3 implies that one is using the water transfer from the rinse circuit to the wash circuit, needed for preventing a water deficit in the wash circuit, as a pre-rinse before the vehicle leaves the wash zone or the flow from the wash-gutter is shifted-over from the wash position to the rinse position. Other forms for this transfer are of course within the scoop of the invention, too, but transfer by pre-rinsing is strongly preferred, especially in the alternatives according to FIGS. 2 and 3.

The final rinsing may be done with pure water, but, if the demands are high that the car, even at humid weather, shall be dry and have high lustre at leaving the wash, the final rinsing may be done with rinse agent additions, too. Disregarding if a rinse agent is used or not it is a large advantage if the final rinsing is done with heated water. Heating lowers the surface tension of the water and gives better sheeting. To this should be added that the higher temperature shortens the drying time.

At plants of this kind, with recycling, dirty water, smelling problems may occur caused by anaerobic conditions, especially if the circulation is allowed to stop for a longer period. To avoid this the plant for should be designed so that aeration, i.e. blowing in air under the liquid surface can be done at critical places. Suitable places may be the recovery section in the sludge/oil separator 8, the buffer-tank 10 for wash water, the sludge/oil separator for rinse water 19 and/or the buffer-tank for rinse water 14. Even with such arrangements, problems may arise and it is important to arrange partial streams through storage and buffer-tanks and belonging pipes and filters for wash and rinse water during periods, when the plant is not in operation.

Preferred defatting agents for use at the process of the invention are, inter alia, those described in the Swedish patent 9002608-9 (468855) and PCT/SE91/00524 (WO92/02665), i.e. water and electrolyte containing micro emulsions obtained by the mixing with water of a liquid, self-emulsifying composition, which is water-free or almost water-free and contains one or more nonionic surface-active agents, one or more organic solvents, which mainly are low polar or not polar and one or more surface-active agents with a load-giving function. These surface-active agents are cationic surface-active agents and/or potentially cationic surface-active agents and/or ampholyte or zwitterionic surface-active agents or anionic phosphate esters. Further electrolytes and complexing agents are included in the mixture. An especially preferred complexing agent is NTA. The mixing is done at the user's place to reduce transport volume. pH in the mixture should be between 8 and 12.

As an alternative if the cars have no or just few asphalt-stains compositions according to SE 9003599-9 (500534), PCT/SE91/00764 and EP 0557364 may be suitable. These compositions may also be used as shampoo to reinforce the wash-efficiency of the recycling cleaning solution. Such compositions consist of water containing, alkaline mixtures of surface-active agents and electrolytes and are obtained by letting a self-mixing pre-mixture mix itself with water and electrolyte. The pre-mixtures are thinly fluid and water-free or almost water-free and contain one or more nonionic surface-active agents and one or more surface-active agents with load-giving function. If the pre-mixtures do not already contain electrolytes, it is added at the mixing. The load-giving surface-active agents are cationic surface-active agents which at least partly contain hydroxyl and/or ether groups, potentially cationic surface-active agents as ampholyte and/or zwitterionic surface-active agents or anionic phosphate esters. The final mixture contains also one or more complexing agents for polyvalent metal ions. Here too, an especially preferred complexing agent is NTA.

Cationic or potentially cationic load-giving surface-active agents are preferred as they have a favourable effect for reducing metal corrosion. Special purposes may require that other compositions are used, too, but the mentioned ones are preferred.

To improve sedimentation and filtering different precipitating agents may be used. A preferred agent consists of soluble, not complex-forming salts with polyvalent anions. Suitable compositions are described in SE9101290-6 (469060), SE9201428-1 (500177), PCT/SE93/00394 (WO93/22242), SE9401461-0 and PCT/SE95/00477 (WO95/29877). This precipitating agent may be added, for instance, at every wash and causes a better separation of oils and other hydrophobic dirt. This is especially true if the cleaning agent contains cationic surface-active agents with hydrotropic properties.

Agents of this kind have also a favourable influence concerning elimination of hardness formers, preventing of corrosion and stabilising of pH. Even if the demands on total removal of oils, hydrophobic dirt and heavy metals are not equally essential in a system without discharges, addition is recommended even when it from other aspects is judged less important.

When conditions are not too unfavourable, using this first precipitating agent may be sufficient. At heavier contamination, which may occur wintertime, the first agent may be completed with a second, precipitating agent according to the process described in SE9702056-4 and PCT/SE98/01027 (WO98/54097).

This process is described as a process for the purifying of an alkaline wastewater containing anionic compounds that may react with calcium and form water-insoluble precipitates. The process comprises the stages: a) adjustment to a suitable pH between 9 and 11, b) addition of a precipitating agent consisting of a water solution, which is formed by dissolving in water of a pulverous mixture of a soluble calcium salt and a cationic polymer with molecular weight in the range 1 to 12 millions in the proportions by weight of 10:1 to 100:1, in such amount that it corresponds to 0.001 to 3 g calcium ion and corresponding amount polymer per litre wastewater, and c) removal of the formed precipitate by use of known technique for the separation of solid and liquid substances.

When it is important to retard salt accumulation, the best alternative may be a combination, where the soluble calcium salt wholly or partly consists of calcium hydroxides.

When the second precipitating agent is used at car washes with recycling wash solution, the precipitating agent should not be added at every wash, but surge-wise after a suitable number of washes. In this way an optimal utilisation of both precipitating agents is obtained. The principles and benefit of the surge-wise dosing are described more in detail in the mentioned patent application.

When both precipitating agents are used, it is very important that the first agent is always present in surplus so that rest amounts, which are not needed for the precipitating, remains in the returned wash solution. If this is not observed grave danger exist that washes with recycling wash water may cause increased corrosion compared with washes without recycling. With surplus of the first precipitating agent the risk for corrosion is reduced very much.

All agents used in the wash part must be composed so that they in co-operation give an alkaline pH. Preferably the pH shall be over 8. A preferred interval is 8.5 to 11.5.

In the rinse circuit pH may with advantage be neutral or even weakly sour. The rinsing should be done by the method and the agents described in SE9704503-3 and PCT/SE98/02209.

It should be observed that the descriptions of wash and cleaning routines above are examples and should not be interpreted as limiting for the invention. For a man of the art it is obvious that the basic theme of the invention allows many variations regarding choice of washing machines, wash and cleaning routines and chemicals used. A far-reaching adaptation to local conditions with regard to water quality etc. is also possible.

1. Process for washing of solid objects, specially vehicles and especially passenger cars, with wash water, which is recycled in a circuit, characterised in that the rinsing is started with a recycling rinse water having its own circuit separate from the wash water circuit and is finished with a final rinsing which includes use of purified wash water that via a balancing circuit has been returned from an earlier recycling stage, with respect to the wash process.

2. The process of claim 1 characterised in that the wash water circuit and the rinse water circuit are balanced against each other in such a way that the water addition to the rinse system corresponds to the water loss through withdraw, so that no waste water from the plant arises.

3. The process of claim 2 characterised in that balancing is done with the aid of a balancing circuit comprising ultra and/or RO-filtration (RO stands for reverse osmosis).

4. The process of claim 2 characterised in that balancing is done with the aid of a distillation circuit to retard salt accumulation in the wash water.

5. Plant for vehicle washing with recycling wash water and recycling rinse water for rinsing in more than one step characterised in that it is provided with separate recycling systems for wash water and rinse water and a balancing system that returns and purifies wash and/or rinse water for use at the final rinsing.

6. The plant of claim 6 characterised in that it has separate zones for washing and rinsing/drying.
